(19) United States
(12) Patent Application Publication
(10) Pub. No.: US 2004/0085392 A1
(43) Pub. Date: May 6, 2004

(54) Printing apparatus and method

(76) Inventors: Simon Walsh, Dublin (IE); Paul Killeen, Kildare (IE)

Correspondence Address: LADAS & PARRY, Suite 2100, 5670 Wilshire Boulevard, Los Angeles, CA, 90036-5679, US

(21) Appl. No.: 10/285,354

(22) Filed: Oct. 30, 2002

(51) Int. Cl. B41J 2/165

(52) U.S. Cl. 347/36

(57) ABSTRACT

An inkjet device comprising a service station and a printhead, said service station comprising an ink spreader and a spittoon, said spittoon having an ink receiving surface arranged to receive ink spitted from said printhead, said ink spreader being arranged to spread spitted ink in a substantially unbroken layer over at least a portion said ink receiving surface.

### FILED OF THE INVENTION

The present invention relates generally to hardcopy devices, particularly but not exclusively to inkjet printers and to methods and apparatus for servicing such devices.

### BACKGROUND TO THE INVENTION

As is well known in the art, conventional inkjet printers generally employ one or more inkjet cartridges, often called “pens”, which eject drops of ink onto a page or sheet of print media. For instance, two earlier thermal ink ejection mechanisms are shown in U.S. Pat. Nos. 5,278,584 and 4,683,481, both assigned to Hewlett-Packard Company. The pens are usually mounted on a carriage, which is arranged to scan across a scan axis relative to a sheet of print media as the pens print a series of individual drops of ink on the print media. The series of drops collectively form a band or “swath” of an image, such as a picture, chart or text. Between scans, the print medium is advanced relative to the scan axis. In this manner, an image may be incrementally printed.

In order to ensure satisfactory print quality, a “service station” apparatus is typically located within the printer chassis, laterally offset to one side of the printzone, so that the printheads can be periodically moved to a servicing position and serviced. Such service stations usually include a number of elastomeric wipers, used to wipe the printhead surface with an ink solvent, such as a polyethylene glycol (“PEG”) compound, to remove any ink residue, paper dust, or other matter that has collected on the face of the printhead. Additionally, service stations usually include one or more reservoirs, termed “spittoons” which are designed to receive and store drops of ink ejected during “spitting” operations. “Spitting” is the term given to the process by which a number of ink drops are fired through one or more nozzles of a printhead in order to remove a blockage in the nozzle caused by dried ink or other matter. Service stations may also include a capping system that seals and protects the printhead nozzles from contaminants and drying out during non-printing periods.

One example of a servicing station for an inkjet device is disclosed in U.S. Pat. NO. 6,203,135 entitled “Independent Servicing Of Multiple Inkjet Printheads”, in the name of Hewlett-Packard Co.

When spitting processes are carried out with pens that are arranged to print pigmented ink, stalagmites often form in the spittoons. This is often the case with black ink, as pigmented black ink is often used in preference to black dye based ink, due to its superior text print quality. However, this problem is also known to arise with other colours of pigmented ink. If a stalagmite is free to grow unchecked, it will eventually reach the level of the bottom of the printhead whose spitting is causing the stalagmite. When this happens, the top of the stalagmite will smear the underside of the printhead. This can damage the nozzle plate of the printhead or block ink ejection nozzles.

It would therefore be desirable to provide a printer device, servicing apparatus and a servicing method for servicing such devices, which addresses this issue.

### SUMMARY OF THE INVENTION

According to one aspect of the present invention there is provided an inkjet device comprising a service station and a printhead, said service station comprising an ink spreader and a spittoon, said spittoon having an ink receiving surface arranged to receive ink spitted from said printhead, said ink spreader being arranged to spread spitted ink in a substantially unbroken layer over at least a portion said ink receiving surface.

By using an ink spreading tool to periodically spread or redistribute spitted ink located in the spittoon, the formation of ink stalagmites may be prevented. Furthermore, by using a spreading or wiping action, the spitted ink may be redistributed across the ink receiving surface, which may be the base portion or floor of the spittoon, whilst it is still wet. This means that the ink may be redistributed before it dries. Preferably, the redistributed and dried ink forms a contiguous, relatively even layer across at least part of the ink receiving surface.

Thus, in a preferred embodiment, the spitted ink dries as a single piece or cake; and as such, may be described as being monolithic. Over a period of time, further layers of spitted ink may be added to earlier layers. In this manner a single cake of spitted ink may be composed of the ink ejected during many spitting operations. Thus, after a one or more ink spreading operations, the ink receiving surface may be formed of previously spread ink. Depending on the spitting servicing characteristics being employed, the previously spread ink may be either wet or dry. Since the spitted ink dries as a single piece or a few relatively large pieces, it is likely to stay in the spittoon, even if the spittoon or the printer is turned upside down, for example. Indeed in one embodiment, the spittoon is formed with a lip around its upper rim, preventing large pieces of dried ink from escaping from the spittoon.

Preferably, the spreading action is implemented relatively soon after a spitting is operation. In this manner, the spitted ink will still be liquid or substantially wet when the spreading action is implemented and thus the ink may be easily spread.

Preferably, the spreading or wiping surface of the ink spreader is located, at least during the spreading process, relatively near to, or contacting the ink receiving surface. In this manner, the height of the dried ink cake in the spittoon may be kept to a relatively low level. This in turn may prolong the usable life of the spittoon.

In one preferred embodiment of the invention, the ink spreader is driven by the mechanism used to move printhead wipers relative to the printhead. This provides a cost effective drive solution. Furthermore, since printhead wiping operations are usually performed during each servicing operation, it is unlikely that spitted ink will dry before the following printhead wiping process. In this manner, the spitted ink should still be wet during the ink spreading operation, which may occur at the same time as the printhead wiping operation. In one preferred embodiment, the printhead is wiped immediately after a spitting operation. In this manner, the spitted ink is redistributed by the ink spreader almost immediately after being spitted.

Preferably, the printer is a portable printer; i.e. of similar type to the Hewlett-Packard DeskJet 450c. Such portable printers are designed to be frequently transported. Whilst being transported, they are frequently placed upside down, or resting on one side, for example. In such situations, it is likely that small loose particles of pigmented ink, which are conventionally found in prior art spittoons, may escape from the spittoon. Such particles may damage or impede the operation of any one of various subsystems of the printer; for example, the on board sensors, the scan axis drive mechanism or the printheads.

Advantageously, the ink spreading process of the present invention may be used to ensure that a spittoon is filled with ink in an efficient manner; thus, prolonging the useful life of the spittoon or waste ink store by increasing it usable capacity. Therefore, embodiments of the present invention may be applied with benefit to many hardcopy apparatus having an inkjet printing engine, for example fax machines or office printers.

In another aspect of the invention, there is provided a spittoon assembly for use in an inkjet printing device, said assembly comprising a surface arranged to receive spitted ink and an ink spreader, said ink spreader being arranged substantially to contact said surface and to move between first and second positions adjacent said surface in order to limit the formation of pigment stalagmites.

According to the present aspect of the invention, preferably the ink spreading device is formed as a sub-component of the spittoon. It is envisaged that the ink spreading device and the spittoon may be manufactured as a single replaceable unit. In this manner, the user may replace the ink spreading device together with the spittoon at the normal servicing intervals. Thus, no extra effort need be required on the part of the user to carry out routine maintenance of the printer according to certain embodiments of the invention. Furthermore, it is preferably that the ink spreading device, which may take the form of a spatula or paddle, is located substantially inside the spittoon.

The present invention also extends to the corresponding servicing methods. Furthermore, the present invention also extends to a computer program, arranged to implement the methods of the present invention.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 is a top view of a portable inkjet printer in accordance with a first embodiment of the present invention;

FIG. 2 is a perspective schematic view of the wiper assembly and the spittoon illustrated in FIG. 1, illustrating how the ink spreading device is actuated in the first embodiment of the present invention; and,

FIGS. 3a and 3b are schematic diagrams illustrating how spitted ink is spread by the ink spreading device across an ink receiving surface of the spittoon in the first embodiment of the present invention.

### DETAILED DESCRIPTION OF THE BEST MODE FOR CARRYING OUT THE INVENTION

There will now be described examples of the best mode contemplated by the inventors for carrying out the invention.

### FIRST EMBODIMENT

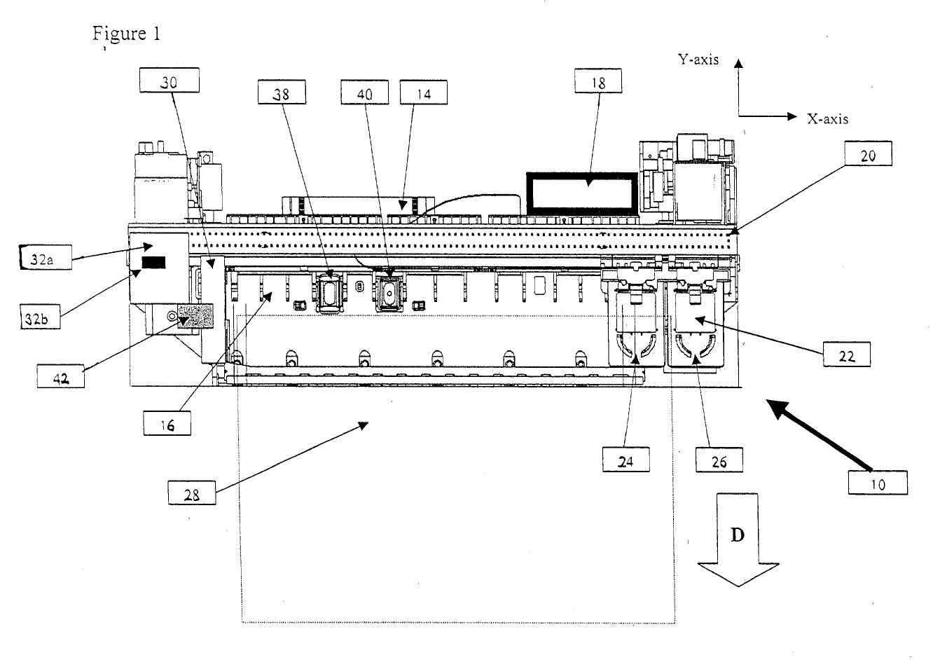

Referring to FIG. 1, a top view of a portable inkjet printer 10 according to the present embodiment is shown. In this example, the printer 10 is of the type designed to be supported on a surface such as a desk top. The printer has a chassis, which is made out of sheet metal material, part of which is referenced 14. The printer also has a casing or cover, typically manufactured from a plastics material. The casing has been left of the illustration in FIG. 1 in order to illustrate the print zone 16 and selected components of the printer described below.

The printer has a printer controller, illustrated schematically as a microprocessor 18, that receives instructions from a host device, which is typically a computer, such as a personal computer or a computer aided drafting (CAD) computer system (not shown). The controller 18 has associated memory (not shown), which includes ROM and RAM. Image data, which is downloaded from a host device, may be stored in the RAM prior to being printed. The ROM stores operating instructions, which the controller 18 accesses in order to carry out the functions of the printer.

The printer has a slider rod 20, shown in dotted line, mounted to the body of the printer that defines a scan axis. The scan axis is aligned parallel to the X-axis, as indicated in the figure. A scanning carriage 22, supporting two cartridges 24 and 26, is slideably mounted to the slider rod, allowing the carriage to travel back and forth, reciprocally, across the print zone 16. In the present example, cartridge 24 is arranged to store and print black ink and the cartridge 26 is a tri-colour cartridge, arranged to store and print each of cyan, magenta and yellow ink. In the present embodiment, the black ink printed by the cartridge 24 is a pigmented ink and each of the three inks printed by the tri-colour cartridge 26 is a dye-based ink. In the present embodiment, the cartridges 24 and 26 may be conventional inkjet cartridges employing conventional thermal inkjet printheads, although in other embodiments other types of printheads, such as piezoelectric printheads, may be used.

A conventional carriage drive motor (not shown), such as a stepper motor, is used to propel the carriage across the print zone in response to control signals output by the controller. The controller also outputs firing signals, via a trailer cable (not shown), to the print cartridges in a conventional manner. The firing signals cause the nozzles of the printheads of the respective cartridges to selectively fire at the appropriate times to deposit ink at the desired locations of the print medium.

When a printing operation is initiated, a sheet of print media 28, such as paper or a transparency or the like, is picked from a media input position and transported to the print zone 16 in order to allow a printing operation to be performed. This may be implemented using a conventional sheet feeding mechanism. After a single or multiple printing passes by the carriage across the print zone, the sheet is incrementally advanced through the print zone by the sheet feeding mechanism. Again this process occurs in response to signals output by the controller. In this manner, further swaths of image content may be printed, building up a completed image in a conventional manner. When the printing on the sheet is complete, the sheet is forwarded, in the direction of arrow “D”, to a media output position.

In the present embodiment the controller periodically determines that either or both of the cartridges are should be serviced. This may be, for example, when the printer is switched on, after a predetermined period of time has elapsed since the previous servicing operation was carried out, after the printer has printed a given number of pages, or after a period derived from a combination of these factors. The skilled reader will understand that many methods exist for determining when servicing operations should be implemented in order to balance the requirements of printhead health and throughput. Any suitable such method may be used in combination with the present invention.

The servicing functions of the present embodiment include, spitting, wiping and capping. The servicing components of the printer of the present embodiment are located in three broad areas of the printer.

A spittoon assembly 30 and a wiper assembly 32, both of which are arranged to service the black cartridge 24 exclusively, are located outside the print zone at the left hand end of the scan axis as viewed in FIG. 1.

A further spittoon assembly (not shown) and a wiper assembly (not shown) are located outside the print zone at the right hand end of the scan axis as viewed in FIG. 1. The further spittoon and wiper assemblies are arranged to service the tri-colour pen 26 exclusively. By providing different wiping elements and spittoons for servicing the black cartridge 24 and the tri-colour cartridge 26, the risk of cross contamination of ink supplies may be reduced. For the same reason, it is preferable that both the spittoon assembly and the wiper assembly that are arranged to service the tri-colour cartridge 26 should have different servicing elements for servicing the ink ejection nozzles of the different ink colours.

As stated above, each of the three inks printed by the tri-colour cartridge 26 is a dye-based ink. Therefore, the structure and function of the spittoon assembly and the wiper assembly adapted to service the tri-colour cartridge may be conventional and so will not be described further.

By locating the spittoons and wipers outside of the print zone, it is possible for the spitting operations and wiping operations to be implemented whilst a sheet of print media is located in the print zone. Thus, spitting operations may be implemented whilst a given sheet of print media is located in the print zone. Furthermore, by arranging the wipers and spittoons in a “split” configuration in the present embodiment (i.e. distributed on either side of the print zone), the width of the printer may be reduced. However, the skilled reader will appreciate that neither of these features of the present embodiment are necessary in other embodiments of the invention.

Also shown in FIG. 1 are two caps 38 and 40. These are exclusively arranged to cap the black cartridge 24 and the tri-colour cartridge 26, respectively. The structure and function of the caps 38 and 40 may also be conventional and so will not be described further. However, as can be seen from the figure, the caps are located inside the print zone, since in the present embodiment the capping functions are only required during periods of non-use; i.e. when there is no print media in the print zone. However, the skilled reader will appreciate that this need not be the case in other embodiments of the invention.

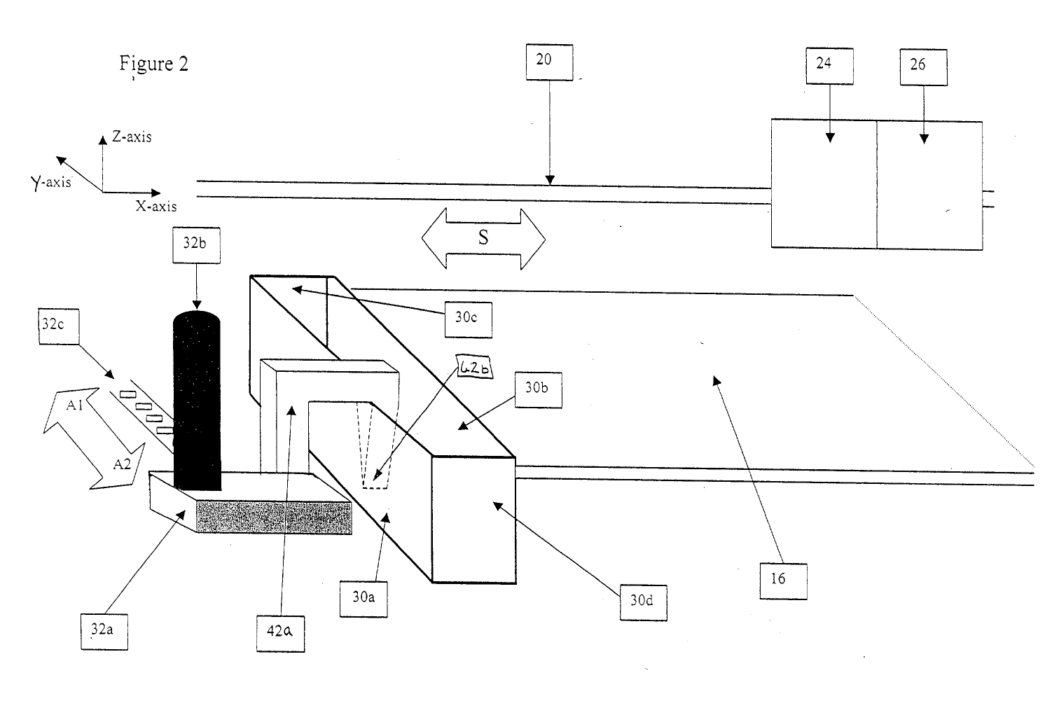

Referring to FIG. 2, the spittoon assembly 30 and the wiper assembly 32 arranged to service the black cartridge 24 will now be described in more detail. FIG. 2 shows a schematic perspective view of selected elements of the printer 10. The figure shows the slider rod 20 together with the black and tri-colour cartridges 24 and 26, located above the platen 16. Also shown in the figure are the spittoon assembly 30 and a wiper assembly 32 located adjacent to one end of the platen 16.

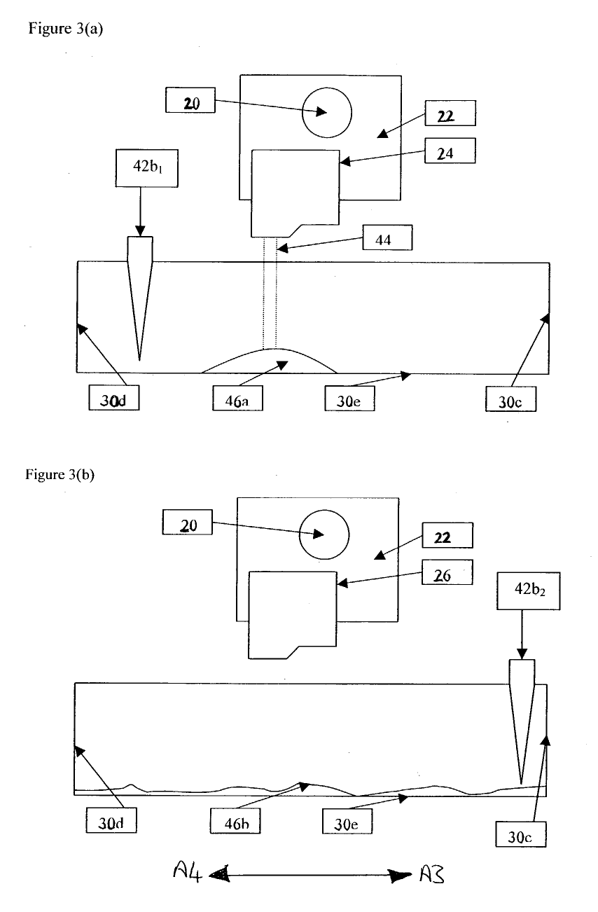

As can be seen from the figure, the spittoon 30 is located generally underneath the slider rod 20, with the top of the spittoon being located at approximately the same height as the media supporting surface of the platen 16. The spittoon 30 is a hollow structure arranged to receive and hold ink. The spittoon has two vertical side walls 30a, 30b and two vertical end walls 30c, 30d, each joined to a base portion 30e, which is illustrated in FIGS. 3a and 3b. In this example, the side walls are aligned parallel to the Y-axis and the end walls are aligned parallel to the X-axis.

The upper side of the spittoon is open, forming an aperture in the spittoon. Thus, when the black cartridge 24 is positioned at the correct position along the scan axis, the nozzle plate of the cartridge 24 is located above the spittoon aperture. In this manner ink which is ejected by nozzles of the cartridge 24 is caught and retained by the spittoon. Preferably, the dimensions of the spittoon are sufficiently large such that each of the nozzles of the cartridge 24 may eject ink into the spittoon whilst the cartridge 24 is located at a single point along the scan axis.

Adjacent to the spittoon, is the wiper assembly 32. In this example, the wiper assembly is located on the opposite side of the spittoon to the print zone. However in other embodiments of the invention, other configuration may be used. The wiper assembly 32 has a platform 32a, on which a conventional wiper element 32b is mounted. The wiper assembly is free to be driven by a conventional motor, under the control of the controller, to implement a wiping process. In the present embodiment, wiper assembly 32 is driven between the first and second extreme positions in a direction parallel to the Y-axis, using a conventional rack and pinion drive mechanism 32c. In FIG. 2, the wiper assembly is illustrated in an intermediate position, between the first and second extreme positions.

In the present embodiment, the wiper assembly starts each wiping cycle in the first extreme position, towards the front of the printer (i.e. the side of the printer on which printed media is output), although this may be varied in other embodiments. When the cartridge 24 is located at the correct position along the scan axis to be wiped and the wiper assembly is located in its first extreme position, the wiper element does not contact the nozzle plate of the cartridge. However, when the wiper is driven in the direction of the arrow A₁ towards the rear of the printer, the wiper element comes into contact with the nozzle plate and passes along the entire length of the nozzle plate in the Y-axis, wiping the nozzle plate as it goes, before reaching the second extreme position. The direction of motion of the wiper assembly is then reversed and the wiper element then passes back along the entire length of the nozzle plate in the reverse direction, in the direction of the arrow A₂, until it once again reaches the first extreme position.

An ink spreader device 42 is also shown in FIG. 2. The spreader device 42 in the present embodiment has an arm structure 42a and an ink spreading tool or surface 42b. In the present embodiment, the ink spreading tool may form part or all of the portion of the ink spreader device which extends approximately downwards into the spittoon. In the present embodiment, the arm structure 42a is rigidly connected to the platform 32a of the wiper assembly. The arm structure 42a and the platform 32a may be made from one or more injection moulded plastic parts or any other suitable materials. The tool or surface 42b is rigidly connected to the arm structure 42a using any convenient technique, such as adhesive bonding or mechanical fixing such as a screw. However, the tool itself is preferably flexible. The tool may be made out of a strip of suitable sheet metal, plastic or rubber, for example. The flexibility of the tool allows it to deform against the layers of dried ink held in the spittoon. This is particularly useful as the spittoon fills with dried ink. In this manner, the ink spreader device may continue to redistribute spitted ink and to prevent stalagmites as the depth of dried ink in the spittoon increases, without the ink spreader device jamming against the dried ink. In this manner, the period of time which the spittoon may be used for without requiring maintenance may be increased. Alternatively, or additionally, the tool may be spring mounted in the vertical direction. In this manner, the tool may be biased toward the ink receiving surface of the spittoon. However, as the level of dried ink in the spittoon rises, the tool may rise, against the biasing force of the spring.

The shape of the ink contacting surface of the tool may vary. The ink contacting surface may be a two dimensional surface or may alternatively be approximately a line contact. However, preferably it lies substantially parallel with the nozzle plate of the cartridge 24 in the direction of the X-axis. In this manner, when the ink is spread, it will lie approximately planar to the nozzle plate of the cartridge 24. Furthermore, in the present embodiment, both the nozzle plate of the cartridge 24 and the base of the spittoon are arranged to be horizontal. Thus, by spreading the ink in the spittoon such that it lies in a horizontal layer, the spittoon may be efficiently filled with ink over the working life of the spittoon. This gives rise to reduced material servicing costs in terms of replacement spittoons over the life of the printer, as well as a reduced requirement for user implemented servicing operations.

Similarly, the width of the ink contacting surface of the tool in the X-axis may also vary. However, preferably it is sufficiently wide and suitably located in the spittoon in order to ensure that it spreads the great majority, or all of the ink spitted ejected into the spittoon. In this manner, the spread ink may be maintained as an approximately flat layer across the base of the spittoon. Thus, in the present embodiment, the width of the ink contacting surface of the tool in the X-axis is approximately the same width as the nozzle plate of the cartridge 24.

The distance between the upper surface of the base portion 30e of the spittoon and the nearest part of the undeformed ink spreading tool may also vary. The ink spreading tool may be designed to contact the upper surface of the base portion 30e of the spittoon when the spittoon contains no ink. Alternatively, there may be a gap between the ink spreading tool and the upper surface of the base portion 30e of the spittoon when the spittoon contains no ink. This may allow dried pigmented ink to build up to a certain extent, before the ink spreading tool contacts recently spitted ink. The desired distance between the upper surface of the base portion 30e of the spittoon and the position of the undeformed ink spreading tool will depend upon the characteristics of a given hard copy apparatus and so may be determined using conventional experimentation.

As can be seen from the figure, the arm structure 42a is suitably shaped in order to permit the tool 42b to be located inside the spittoon. In this manner, as the wiper assembly 32 is driven between its first and second extreme positions along the rack of the rack and pinion drive, the tool 42b is similarly driven between first and second extreme positions along the length of the spittoon. In the present embodiment, the dimensions and relative positions of the spittoon and the tool 42b in the Y-axis are preferably selected such that the end walls of the spittoon 30c, 30d do not obstruct the movement of the tool 42b as it travels up and down the length of the spittoon.

The mode of operation of the present embodiment will now be described with reference to FIGS. 3a and 3b.

FIGS. 3a and 3b schematically illustrate cross sectional views of the apparatus shown in FIG. 2. The cross sectional views each lie parallel to the Y-axis, passing through the centre of the spittoon 30 along its longitudinal length. Thus, one side wall 30a, both end walls 30c, 30d and the base portion 30e of the spittoon are shown. The ink spreading tool 42b of the spreader device 42 is also illustrated. Furthermore, the slider rod 20, here viewed end on, can also be seen. As is described below, the position of the scanning carriage is different between the FIGS. 3a and 3b. Thus, the cartridge 24 can be seen in FIG. 3a and the cartridge 26 can be seen in FIG. 3b.

The scanning carriage 22 is first moved to the correct position along the slider rod such that the cartridge 24 may spit in the spittoon. This is illustrated in FIG. 3a. A spitting routine is then implemented in a conventional manner. Thus, selected nozzles are controlled to eject ink drops 44 into the spittoon. This causes a build of pigmented ink that forms a mound 46a on the base 30e of the spittoon. In the present embodiment the wiper assembly is located in its first extreme position during the spitting routine. Consequentially, the spreading tool 42b is also located in its first extreme position during the spitting routine. In FIG. 3a, the spreading tool is shown in its first extreme position and is referenced 42b₁.

The scanning carriage 22 is then moved to the correct position along the slider rod, so that the cartridge 24 may be wiped by the wiping assembly. This is illustrated in FIG. 3b. A nozzle plate wiping routine is then implemented as is described above. As the wiper assembly wipes the nozzles plate of the cartridge 24, the spreading tool 42b moves from its first extreme position to its second extreme position, in the direction of arrow A₃. This is illustrated in FIG. 3b, where the spreading tool shown in its second extreme position and is referenced 42b₂. The spreading tool then returns, in the direction of arrow A₄, to its first extreme position at the end of the printhead wiping cycle.

As can be seen from the FIG. 3b, the effect of the spreading tool 42b moving between its extreme positions in the spittoon is to flatten the mound 46a of pigmented ink, spreading it in a relatively even thin layer 46b over a large area of the base portion 30e of the spittoon. It will be understood that in the present embodiment, the action of the ink spreader on the ejected ink is one of spreading, wiping or smearing the ink. Thus, the action of spreading the ink occurs in a reasonably progressive manner. Furthermore, the ink is spread over a length of the ink receiving surface of the spittoon in a reasonably continuous manner. As is schematically illustrated in FIG. 3b, the spread ink forms a relatively uninterrupted or unbroken layer.

By implementing the wiping routine immediately after the spitting routine, it may be ensured that the spitted ink will have dried very little. This may ensure that the ink spreading function works efficiently. However, the skilled reader will appreciate that pigmented ink ejected into a spittoon during a spitting routine dries comparatively slowly. It is not uncommon, for example, for pigmented ink in a spittoon to still be wet several hours subsequent to being spitted. Therefore, the present embodiment may equally be applied to a hard copy apparatus that implements wiping routines only after a considerable delay after implementing the preceding spitting routine.

Once the wiping process is completed, a further wiping process may be carried out in the normal manner should this be required. Then the process of printing may continue in a normal manner. Alternatively, the tri-colour cartridge may be serviced in a conventional manner, or the cartridges may be capped if no further printing is required.

### FURTHER EMBODIMENTS

In the above embodiment numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

For example, in certain embodiments of the invention, a rigid ink spreader tool may be used in place of the flexible ink spreader tool described in the embodiment above. In one such embodiment a relatively long spittoon is used and only a small gap may be left between the upper surface of the base portion of the spittoon and the ink spreading tool. In this manner, almost all of the ink which is deposited in the spittoon during a spitting routine may be moved to a point in the spittoon which is relatively distant to the position of the printhead or cartridge during a spitting position. Thus, although this may create a mound of dried pigmented ink in the spittoon, it should be at a non-critical position regarding the printhead or cartridge.

In such an embodiment, the spreader device, including the arm structure and the ink spreading tool may be made from one or more injection moulded plastic parts. The rigid ink spreader tool may, however, be arranged to pivot to a limited degree about its supporting arm. This may ensure that the wiping cycle does not eventually become obstructed by the effect of dried ink jamming the ink spreader tool.

In one further embodiment, the spittoon is formed with a lip around its upper rim, forming a relatively small aperture through which a pen may spit, in relation to the area of the ink receiving surface of the spittoon. The dimensions of the aperture may, for example, be selected to be just large enough to allow all of the nozzles of the associated cartridge to spit through at the same time into the spittoon. The ink spreader, however, may be arranged to spread the ink out to an area greater that that of the aperture by making the area of the ink receiving surface of the spittoon significantly larger than that of the aperture in the X direction, the Y direction, or both. In this manner, if the dried ink becomes detached from the inside surface of the spittoon, it should not be able to pass through the aperture and thus escape from the spittoon.

In the above-described embodiment, the arm structure of the ink spreader device is rigidly connected to the platform of the wiper assembly. In other embodiments, though, this need not be the case. For example, the ink spreader device need not be actuated by the wiper process. Instead, it may be driven by a dedicated motor controlled by the controller. Alternatively, the ink spreader device may be free to move between first and second positions in a groove or track, for example. The wiper assembly may be arranged to drive the ink spreader device along the groove or track in a first direction against a spring biasing force. The spring biasing force may be used to drive the ink spreader device in the reverse direction, when the wiper assembly subsequently retreats. Furthermore, the ink spreader device may be arranged to be driven in both directions by the wiper assembly, however, using a conventional cam and cam follower arrangement; where the cam is connected to the wiper carriage and the cam follower is connected to the ink spreader device. Such a cam arrangement may drive the ink spreader device either linearly or may drive it to rotate about a point of rotation between its first and second extreme positions.

Additionally, although in the above-described embodiment, only one of the two pens or cartridges prints with pigmented ink, it will be understood that in other embodiments more pens which print with pigmented ink may be employed. In such cases, it will be understood that each of the pens which are arranged to print with pigmented ink may be provided with a spittoon equipped with an ink spreading device.

In one further embodiment, ink spreading operations may be implemented by the controller in order to help dry large quantities of ink which have been spitted into the spittoon in a short period of time. For example, when a new pen is installed in a printer, it is conventional to spit a large quantity of ink before printing with the pen. If more than one pen is installed, either at the same time or consecutively (for example due to pen failure) an even larger quantity of ink may be spitted. It is not uncommon in such situations for up to 5 millilitres of ink to be spitted into a spittoon in a relatively short period of time. In such cases, damaging leakages of spitted ink from the spittoon may occur if the spittoon or the printer are not supported in the correct orientation. Therefore, it is beneficial to dry the spitted ink quickly. In this embodiment, this is facilitated by implementing an ink spreading operation as described above at determined times. By implementing an ink spreading operation the spitted ink is distributed over a relatively large area. This has the effect of increasing the surface area of the ink and so reducing the drying time as well as reducing the tendency of the ink to run. In this embodiment, the controller monitors the approximate volume of ink spitted since the previous ink spreading operation was implemented. This may be achieved using conventional techniques. For example counting the number of drops spitted and multiplying this figure by the known average drop volume. When a given volume of ink has been spitted since the previous ink spreading operation, the controller may implement an ink spreading operation as described above. It will be appreciated that the ink spreading operation may be carried out either in conjunction with, or without implementing a nozzle plate wiping process, as the particular servicing requirements dictate. It will be appreciated that the threshold volume of ink which must be spitted, subsequent to previous ink spreading operation, in order to initiate a further ink spreading operation may be selected in dependence upon the operational requirements of the given system. However, a value such as 1 millilitre may usefully be used in certain systems.

It will be understood that the ink spreading arrangement of the embodiments of the present invention may be used to fill a spittoon with ink in an efficient manner; thus, prolonging the useful life of the spittoon. Thus, although the above-described embodiment was described with reference to a portable printer, the skilled reader will appreciate that the present invention may be applied with benefit to a wide range of printers or hardcopy devices that incorporate an inkjet printing engine in order to benefit from this advantage. Example of such devices may include copiers and fax machines and all in-one-devices, sometimes known as multi-function printers, and the like.

The skilled reader will appreciate that the various further embodiments described herein may be used in combination with one or more of the remaining embodiments.

What is claimed is:

1. An inkjet device comprising a service station and a printhead, said service station comprising an ink spreader and a spittoon, said spittoon having an ink receiving surface arranged to receive ink spitted from said printhead, said ink spreader being arranged to spread spitted ink in a substantially unbroken layer over at least a portion said ink receiving surface.

2. A device according to claim 1, wherein said ink spreader comprises an ink spreading member or blade arranged substantially to contact said ink receiving surface whilst spreading said ink.

3. A device according to claim 2, wherein said ink spreader comprises a flexible ink spreading member or blade.

4. A device according to claim 1, wherein said ink spreader is located substantially inside said spittoon.

5. A device according to claim 1, wherein said device is arranged to actuate said ink spreader to spread said spitted ink over said ink receiving surface whilst said spitted ink is substantially wet.

6. A device according to claim 5, wherein said printhead is arranged to spit onto said ink receiving surface at determined intervals, said ink spreader being arranged to spread spitted ink over said ink receiving surface after substantially each spitting operation.

7. A device according to claim 1, wherein said device further comprises one or more wiping elements arranged to wipe said printhead, said ink spreader and said wiping elements sharing a common drive mechanism.

8. A device according to claim 7, wherein said one or more wiping elements are mounted to a support structure, said ink spreader being connected to said support structure.

9. A device according to claim 7, wherein said ink spreader an ink spreading stroke, said stroke being substantially linear.

10. A device according to claim 1, wherein said printhead is arranged to print with pigmented ink.

11. A device according to claim 1, wherein said device is a portable printer.

12. A device according to claim 1, wherein said device is a thermal inkjet printer.

13. An inkjet printing device comprising a printhead, a spittoon having a surface arranged to receive ink spitted from said printhead, and a spatula, said spatula arranged to wipe spitted ink across said surface whilst said spitted ink is still substantially wet.

14. An inkjet printing device comprising a printhead arranged to print with pigmented ink, a spittoon having a surface arranged to receive ink spitted from said printhead and an ink spreader, said ink spreader being arranged substantially to contact said surface and to move between first and second positions adjacent said surface in order to limit the formation of pigment stalagmites in the region of said spitting.

15. A spittoon assembly for use in an inkjet printing device, said assembly comprising a surface arranged to receive spitted ink and an ink spreader, said ink spreader being arranged substantially to contact said surface and to move between first and second positions adjacent said surface in order to limit the formation of pigment stalagmites.

16. A printer servicing system comprising a waste ink store and an ink spreader, said ink spreader being arranged to redistribute substantially liquid waste ink in said store so as to increase the usable capacity of said store.

17. A method of servicing an inkjet printhead, said method comprising the steps of:
spitting ink from said printhead onto an ink receiving surface of a spittoon;
redistributing ink spitted on said surface by moving an ink spreader across said ink receiving surface from a first position to a second position, such that said ink spreader remains substantially in contact with said ink receiving surface, in order to limit the formation of stalagmites between said first and second positions.

18. A method according to claim 17, wherein said step of moving said ink spreader is implemented whilst said spitted ink is substantially wet.

19. A method according to claim 18, wherein said step of moving said ink spreader spreads said spitted ink as a substantially unbroken layer across at least a portion said ink receiving surface.

20. A method according to claim 17, wherein said step of moving said ink spreader is implemented in dependence upon the volume of ink spitted onto said ink receiving surface.

21. In an inkjet hardcopy device, a method of improving the dry time of ink spitted onto an ink receiving surface of a waste ink store, comprising the step of spreading said ink over at least a portion of said surface with an ink spreader.

22. A computer program comprising program code means for performing the method steps of any one of claims 17 to 21 when said program is run on a processing means associated with a suitable printer system.
